(19) United States
(12) Patent Application Publication
(10) Pub. No.: US 2024/0418275 A1
(43) Pub. Date: Dec. 19, 2024

(54) Rotary Shear Valve

(71) Applicant: Milwaukee Electric Tool Corporation, Brookfield, WI (US)

(72) Inventor: Jean Mauricio Uruena Montoya, Wauwatosa, WI (US)

(21) Appl. No.: 18/742,683

(22) Filed: Jun. 13, 2024

Related U.S. Application Data
(60) Provisional application No. 63/508,250, filed on Jun. 14, 2023.

(51) Int. Cl. F16K 11/074; F15B 13/04

(52) U.S. Cl. CPC F16K 11/0743; F15B 13/0406; F15B 2211/30525

(57) ABSTRACT

A rotor for a directional control valve includes a rotor body defining a sealing surface, a circumferential side surface, and a stem that receives a rotational input to rotate the rotor about an axis. A first opening is formed in the sealing surface and defines a first perimeter. The first opening is positioned to move along a rotation path as the rotor body rotates and has a first notch that extends from the first perimeter toward a centerline of the rotor body that is perpendicular to the axis and along the rotation path. A second opening is formed in the sealing surface and defines a second perimeter. The second opening is positioned to move along the rotation path as the rotor body rotates and has a second notch that extends from the second perimeter toward the centerline of the rotor body and along the rotation path.

### CROSS-REFERENCE TO RELATED APPLICATIONS

The present application claims the benefit of U.S. Provisional Patent Application No. 63/508,250, filed on Jun. 14, 2023, the entire contents of which are incorporated herein by reference.

### BACKGROUND

Hydraulic tools and pumps can include one or more control valves, such as directional control valves, to connect and disconnect fluid pathways, including parts of a hydraulic circuit. Some control valves can include rotary shear seal valves having a rotor.

### SUMMARY

Examples of the invention provide systems and methods of a directional control valve. Directional control valves can include rotary valves, such as rotary shear seal valves. Some examples of rotary shear seal valves include a four-way, three-position valves.

According to one aspect of the present disclosure, a rotor for a directional control valve can include a rotor body defining a sealing surface, a circumferential side surface, and a stem. The stem may receive a rotational input to rotate the rotor about an axis. The rotor can also include a first opening formed in the sealing surface and defines a first perimeter. The first opening is positioned to move along a rotation path as the rotor body rotates. The first opening has a first notch that extends from the first perimeter toward a centerline of the rotor body that is perpendicular to the axis and along the rotation path. The rotor may further include a second opening formed in the sealing surface that defines a second perimeter. The second opening may be positioned to move along the rotation path as the rotor body rotates. The second opening has a second notch that extends from the second perimeter toward the centerline of the rotor body and along the rotation path.

In some examples, each of the first perimeter and the second perimeter has a circular shape and each of the first notch and the second notch may be formed as a triangular portion.

In some examples, the triangular portion may define an arcuate base and a peak opposite the arcuate base. The rotation path may bisect the arcuate base and intersects the peak.

In some examples, the rotor may further include a third opening formed in the sealing surface and defines a third perimeter. The third perimeter may define a circular shape that has an open area that is less than an open area of the first opening. The rotor may also include a fourth opening formed in the sealing surface that defines a fourth perimeter. The fourth perimeter may define a circular geometry and a surface area less than the first perimeter of the first opening.

In some examples, the first and the second openings may be in fluid communication with each other. The third and the fourth openings may be in fluid communication with each other.

In some examples, the first notch and the second notch may be shaped to facilitate a linear decrease in pressure when the rotor is rotated.

In some examples, the directional control valve may be rotated between three positions. A first position may fluidly couple the first opening with a pressure source and the second opening with a tank. A second position may fluidly couple the first opening with the tank and the second opening with the pressure source. A third position may be where the first opening and the second opening are not fluidly coupled to the tank or the pressure source.

In some examples, the first position may correspond to an extension of a piston rod within a cylinder of a piston cylinder assembly. The second position may correspond to a retraction of the piston rod within the cylinder of the piston cylinder assembly.

According to another aspect of the present disclosure, a shear seal control valve may include a valve body that defines first and second ports, and a rotor that is rotatably received in the valve body that has a plurality of openings formed in a mating surface of the rotor. The plurality of openings may be arranged to allow selective coupling of the first and the second ports as the rotor rotates in the valve body. The plurality of openings may include first and second openings that each define a perimeter that has a partially circular portion and a triangular potion. The respective triangular positions may define a notch of the respective first and second openings.

In some examples, the plurality of openings may include a third opening and a fourth opening that define a surface area less than the perimeter of the first opening and the second opening.

In some examples, the first and second openings may be in fluid communication with each other. The third and fourth openings may be in fluid communication with each other.

In some examples, the notches may provide a linear pressure decrease in hydraulic pressure as the rotor is rotated from a first position to a second position.

In some examples, the first opening may be coupled with a pressure source and the second opening may be coupled with the tank in the first position.

In some examples, the first opening may be coupled with the tank and the second opening may be coupled with the pressure source in the second position.

According to another aspect of the present disclosure, a method of operating a piston via a rotary shear seal valve may include rotating a rotor to a first position. A pressure source may be fluidly coupled with a first opening. A second opening may be fluidly coupled with a tank. A piston may be extended within a cylinder of a piston cylinder assembly that causes an operation on a workpiece. A rotor may be rotated to a second position. A first notch of the first opening may be fluidly coupled with the tank. A second notch of the second opening may be fluidly coupled with the pressure source. The piston may be retracted within the cylinder of the piston cylinder assembly.

In some examples, the rotor may rotate in a first rotational direction to reach the first position. The rotor may rotate in a second rotational direction to reach the second position. The first rotational direction may be opposite the first rotational direction.

In some examples, the method may further include rotating a rotor to a third position. The first opening, the second opening, the pressure source, and the tank may be fluidly decoupled.

In some examples, the third position may be a neutral position between the first position and the second position that blocks fluid flow through the first opening and the second opening.

In some examples, the first notch and the second notch may be located on a rotation path of the rotor that increases flow metering.

In some examples, the first notch and the second notch may be triangular-shaped.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a bottom isometric view of a rotor for a rotary valve according to aspects of the disclosure.

FIG. 2 is a side isometric view of a rotary shear valve including a rotor and valve discs.

FIG. 3 is a side isometric view of a rotary valve that includes valve discs and a first port and a second port.

FIG. 4 is a top isometric view of the rotary valve of FIG. 3.

FIG. 5 is a side isometric view of a rotary valve.

FIG. 6A is a bottom view of a rotor of a rotary valve in a first position.

FIG. 6B is a bottom view of the rotary valve of FIG. 4A in a middle position.

FIG. 6C is a bottom view of the rotary valve of FIG. 4A in a second position.

FIG. 7 is an isometric cross-section of a rotary valve in a first position.

FIG. 8 is a bottom view of a rotary valve in an intermediate position.

FIG. 9 is a zoomed in view of a notch on a rotor of a rotary valve.

FIG. 10 is a schematic view of a surface of the rotor of FIG. 1.

FIG. 11 is a zoomed in view of a port from the schematic of FIG. 8.

FIG. 12 is a schematic view of the surface of the rotor of FIG. 1 illustrating exemplary internal passageways of the rotor.

FIG. 13A is a schematic view of a valve in a first position.

FIG. 13B is a schematic view of the valve of FIG. 11A in a middle position.

FIG. 13C is a schematic view of the valve of FIG. 11A in a second position.

FIG. 14A is a schematic view of a valve in a first position and in communication with a piston.

FIG. 14B is a schematic view of the valve of FIG. 12A in a second position and in communication with the piston.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

Pumps, including hydraulic tools having pumps, can include one or more valves to control fluid flow within a tool. Hydraulic tools can be used to perform a variety of operations including crimping, cutting, and pressing work. Some hydraulic tools can include valves, such as shear valves. For example, shear valves can be found in or near a sprocket assembly of a pump of a hydraulic tool. In some instances, the shear valve can be in communication with a cam shaft of the rotary drive system. In other instances, a rotor of a rotary shear seal valve can be in communication with a shaft operatively coupled to the rotor to turn the rotor and move the valve to different positions. The shaft may be rotated by a motor, manually, or combinations thereof.

A directional control valve (DCV) is a device that can control the direction of a fluid. The DCV can connect or disconnect parts of a hydraulic circuit. Some DCVs, including those described herein, can be configured as a 4-way and 3-position rotary shear seal valve. In general, rotary shear seal valves can include a rotor that has a defined layout for port communications. By rotating the rotor, communication between ports can change. Rotary shear seal valve also include shear seal discs that contact the rotor base to seal the ports. A 4-way and 3-position DCV has four ways (e.g., ports), including a first port, a second port, a third port, and a fourth port. For example, the first port can be a Pump Port (P) that connects to a pump, the second port can be a first work port (e.g., Port A (A)) that connects to a work function (e.g., a first end of a hydraulic actuator), the third port can be a third work port (e.g., Port B (B)) that connects to a work function (e.g., a second end of the hydraulic actuator), and the fourth port can be a Tank Port (T) that connects to a tank. The valve can be moved between three positions to selectively connect the four ports. In one particular example a first position (e.g., position “A”) can connect the pump port with the first work port and can connect the second work port to the tank port. A second position (e.g., position “B”) can connect the pump port with the second work port and can connect the first work port to the tank port. A third position (e.g., a neutral position or position “N”) can connect the pump port to the tank port, while blocking the first work port and the second work port. In that regard, the first and second positions can be work positions that cause a work operation to be performed, while the third position is a neutral position that allows hydraulic fluid to drain directly to a tank. Thus, when the rotor is shifted from neutral to A or B, fluid ports in the valve body will line up with fluid ports in the rotor to allow fluid to flow to the selected port.

In general, some hydraulic tools can be used to perform cuts or crimps on a work piece, such as a cable, a connector, or other objects. Generally, hydraulic tools include a cylinder and piston configuration, where the piston is configured to extend and retract within the cylinder, and thus, move jaws, or any other implement coupled to the piston to perform a task (crimping, cutting, lifting, retracting etc.). In some hydraulic tools, a hydraulic circuit can include a two-(or more-) position valve. In a three-position valve, fluid can be directed to extend a piston, which corresponds to a first valve position. In a second position, fluid can be directed to retract a piston. And in a third, or middle position, fluid can be prevented from entering or leaving a piston.

Some embodiments of the invention provide a rotor for a rotary shear seal valve. The rotor can be generally configured as a disk defining a rotor surface (e.g., a planar rotor surface). The rotor can include a plurality of outlet (or inlet) openings formed in the planar rotor surface. Furthermore, the rotor can include one or more auxiliary control paths, diversions, or notches in communication with a respective one of the plurality of outlet ports.

In use, the flow path diversions or notches formed at the perimeter of the of the outlet ports can improve flow metering while lowering a load during lifting applications. In general, a lifting application can include extending a piston (e.g., a hydraulic piston) to move a load against a force (e.g., gravity). The notches can define a triangular (or other) geometry that can help a user to control a flow back for a more significant range of motion during rotor rotation. The notches can advantageously facilitate backflow control and help manage flow metering. Embodiments of the invention provide a rotor having notches or flow path diversions at first and second port outlets (or others) on a rotor of a rotary shear seal valve.

In general, during valve rotation, the notches in the rotor cross a perimeter of the port (i.e., a perimeter of the port formed in a planar surface), which creates an open area (e.g., a flow path diversion) that allows flow from a pressurized port to a reservoir (e.g., a tank). As the angle of rotation increases, the flow can increase because the open area formed at the notch/port perimeter increases. Therefore, depending on the notches' angular location with respect to the port's planar surface perimeter, a user can precisely control the opening area for flow by controlling the angle of the rotor. Without the notches, the angle of controlling the open area is minimal and difficult to precisely manipulate or adjust. That is, by providing notches, the rate of change in open area per degree of rotation is increased at the notches as compared with a main portion of the opening. As a result, a larger magnitude rotation is necessary to increase the open area when only the notches are exposed to form part of the flow path, which allows the open area to be controlled more precisely by a controller during flow metering and also enhances flow stability.

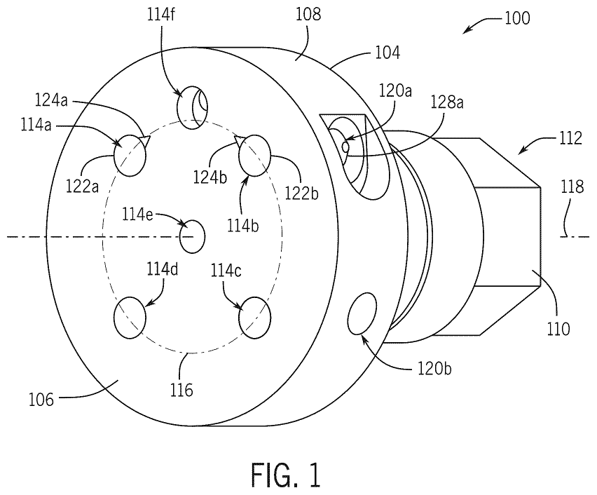

FIGS. 1-14 illustrate aspects of an example valve 102 that allows for improved flow control, as may provide for flow metering, particularly at low flow rates. The valve 102 is configured as a rotary shear valve 102 can be used to control a work operation in a power tool, in particular a hydraulic power tool (e.g., a crimper or cutter), as well as other applications for controlling fluid flow. The rotary shear valve 102 generally includes a valve body 126 having a base 140 and a valve cap 138 that are coupled together and that defines a plurality of ports 142. As illustrated, the valve 102 is configured as four-way, three-position valve having a first port 142b, a second port 142a, a third port 142c, and a fourth port 142d. In this case, the first port 142b is a first work port that couples to a work function, the second port 142 is a second work port that couples to a work function, the third port 142c is a pump port that couples to a pump, and the fourth port is a tank port configured to couple to a tank. In general, fluid flows from the third port 142c and may either flow into the first port 142b, the second port 142a, or flow to the fourth port 142d, depending on the position of the rotor 100, as will be further discussed below. In other applications, more or fewer ports can be provided, and the ports can couple to other external components to meet the needs of a particular application. To that end, each of the ports 142 can be provided with a connector (e.g., a threaded connection, quick-connect fitting, or another type of connection interface) to facilitate a connection to the external components.

A valve is operable between a plurality of positions to selectively connect ports to provide flow control. To connect the ports, a valve includes a control member that is moveable to selectively connect the ports. In the illustrated example, the valve 102 includes a control member that is configured as a rotor 100 that is rotatably retained in the valve body 126. That is, the rotor 100 can rotate within the valve body 126 to selectively connect the ports 142, and described in greater detail below. As shown in FIG. 1, the rotor 100 includes a rotor body 104 that defines a mating surface 106 (e.g., a sealing surface), a circumferential side surface 108, and a stem 110. In general, the stem 110 can provide a rotational control of the rotor 100 and includes an input receiving portion 112. The input receiving portion 112 can receive a manual or motorized input to turn the rotor body 104. The rotor 100 can further define a plurality of openings 114 to selectively connect the ports 142 within the valve body 126. For example, a first opening 114a, a second opening 114b, a third opening 114c, and a fourth opening 114d can be formed in the mating surface 106 and disposed along a rotation path 116 of the rotor 100, so that as the rotor 100 rotates, the openings 114 can be positioned to provide a connection between the ports 142, as described in greater detail below. Furthermore, (auxiliary) openings 114e, 114f can also be disposed within the mating surface 106. In the illustrated embodiment, the opening 114e can be formed at a central location relative to the mating surface 106 and the rotation path 116, and the opening 114f can be configured as a through-hole extending through the disk portion of the rotor in an axial direction (e.g., along an axis of rotation of the rotor).

In some cases, the openings 114 form internal passageways within the rotor body 104. In some cases, the openings 114 on the mating surface can connect with openings on another surface to allow the opening 114 to connect with one or more of the ports 142. For example, with continued reference to FIG. 1, the rotor body 104 can further include openings 120a, 120b that are provided on the circumferential surface 108 of the rotor body 104. In the illustrated example, the opening 120a can be in fluid communication with each of the openings 114a and 114b, and the opening 120b can be in fluid communication with each of the openings 114c and 114d. However, other configurations are possible. Furthermore, one or more of the openings 120 can include a plug 128a. For example, the opening 120a can be plugged so that a fluid pathway only exists distinctly between the first and second ports 114a, 114b formed in the mating surface 106.

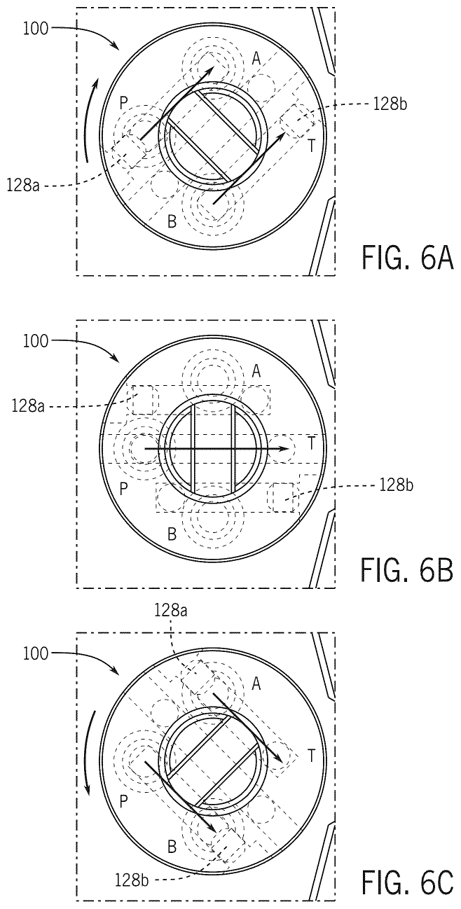

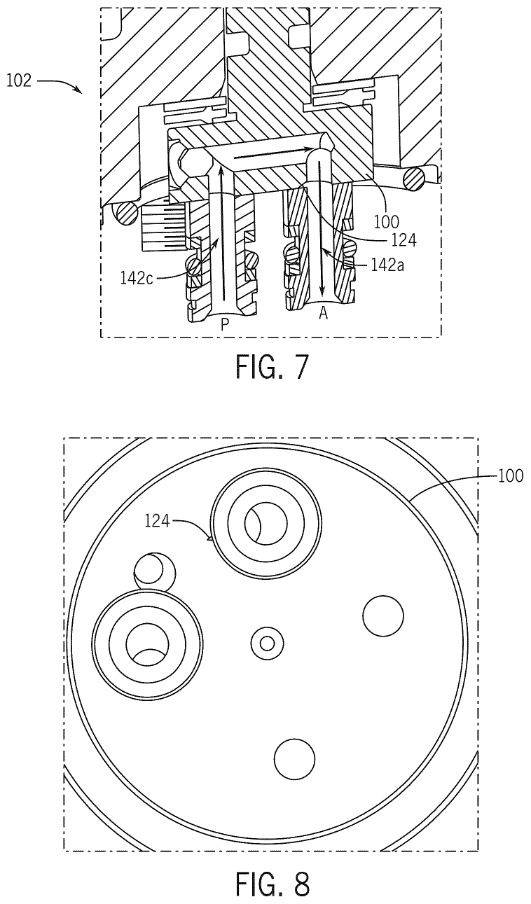

Each of the openings 114a-f can define a respective opening perimeter 122 that defines the opening to the respective port 142. For example, the first and second openings 114a, 114b define respective first and second perimeters 122a, 122b. As will be described further with reference to FIGS. 6 and 7 below, the first and second perimeters 122a, 122b can define respective notches 124a, 124b. The notches 124a, 124b generally form a triangular indentation into the mating surface 106 that is in fluid communication with each of the first and second openings 114a, 114b. That is, for example, if an external planar surface was planarly aligned and butted up against (e.g., flush with) the mating surface 106 of the rotor 100 in the axial direction 118, a discrete pathway would be formed between the first notch 124a, the first opening 114a, the second opening 114b, and the second notch 114b. In other examples, differently shaped or sized notches can be provided to achieve a desired flow characteristic.

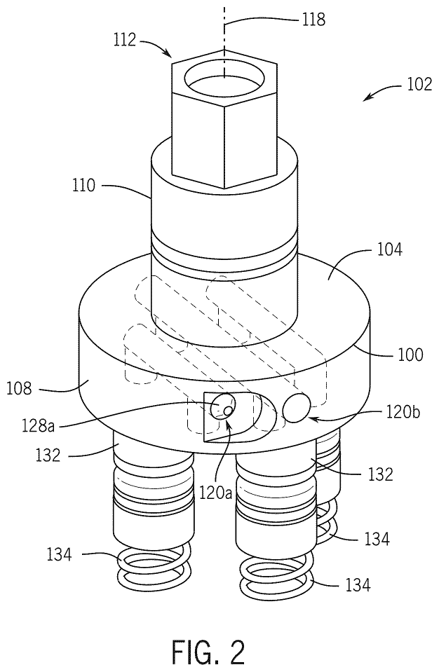

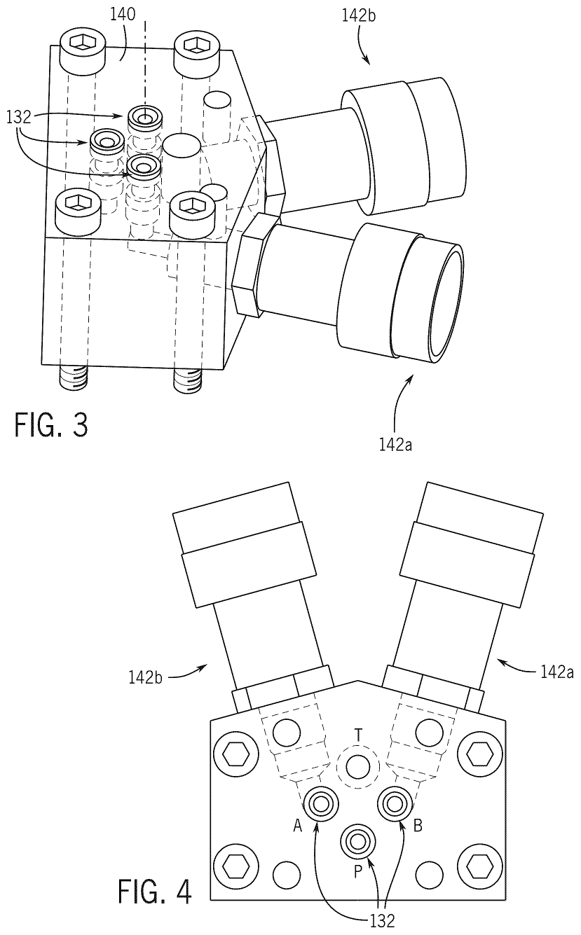

With reference now to FIG. 2, an exemplary assembly of the rotor 100 with the openings 120a, 120b on the circumferential side surface 108 is shown. As described above, the openings 120a, 120b may be in fluid communication with the plurality of openings 114 on the mating surface 106 of the rotor 100. The assembly of FIG. 2 further includes a set of discs 132 and a set of springs 134 that are positioned proximate the mating surface. In the illustration, three discs 132 and three springs 134 are shown in the set of discs 132 and the set of springs 134, respectively, however; other configurations are possible. Furthermore, the valve 102 can include first and second valve ports 142a, 142b (e.g., ports A and B) that extend laterally outward from a base 140 of the rotary shear valve 102 (FIG. 3) and fluidly couple with the plurality of openings 114 of the rotor 100. As shown in FIG. 3, the discs 132 are housed in the base 140 and are biased to contact with the mating surface 106 of the rotor 100 by the springs 134 (e.g., or another type or resilient member, such as a bushing) to provide sealing between the plurality of openings 114 and the valve ports 142a, 142b. More specifically, as shown in FIG. 4, the discs 132 align with the first valve port 142b (e.g., Port A), the second valve port 142a (e.g., Port B), as well as the third port 142c (e.g., Port P). In some cases, the fourth port 142d (e.g., port T) may also include a disc and spring. This alignment allows fluid to flow through each port, while preventing fluid from leaking between each port and the mating surface 106 of the rotor 100.

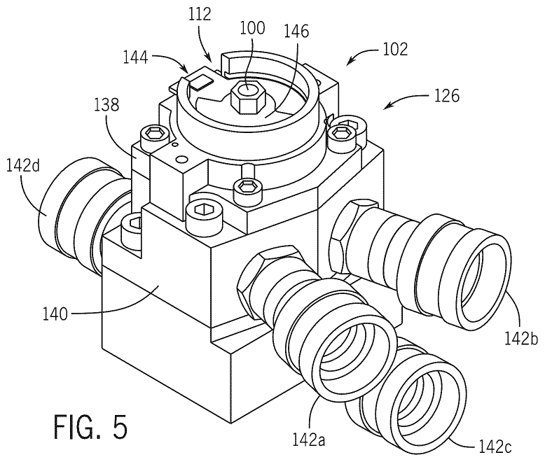

With reference to FIG. 5, an assembled configuration of the rotary shear valve 102 illustrates the rotary shear valve 102 that further includes the rotor 100, the valve cap 138, the base 140, and a sensor 144. The sensor 144 can be used to control the rotor 100 position. The sensor 144 may include a sensor arm 146 that is coupled to the rotor 100 and in fluid communication with the plurality of openings 114. The sensor 144 may be a ZMID (Zinc Metal Ion Detector) sensor or a Hall sensor, however other sensors are possible (e.g., contact switch, position sensors, etc.).

In use, when the valve 102 (i.e., the rotor 100) rotates between a plurality of positions, the valve 102 connects the plurality of openings 114 of the rotor 100 to the ports 142 of the base 140 to direct flow between various combinations of the fourth port 142d, the third port 142c, and the first and second ports 142a, 142b.

FIGS. 6A-C illustrate exemplary orientations of a rotor, such as the rotor 100, rotating between different positions. For example, in FIG. 6A, the first position is shown. In the first position, the pressure port P (the third port 142c) is in fluid communication with Port A (the first port 142b) and the tank T (the fourth port 142d) is in fluid communication with Port B (the second port 142a). When the valve 102 rotates, it connects the cavities to direct flow accordingly. As the rotor 100 rotates in the direction indicated in FIG. 6A to the third position shown in FIG. 6B, the valve is moved to middle or neutral position where neither the tank T nor pressure P are in communication with either port A or B. As the rotor 100 rotates again, the pressure port P can be in fluid communication with Port B and the tank T can be in fluid communication with Port B. Optionally, as shown in FIGS. 6A-C, plugs 128a, 128b may be provided that block fluid flow through the openings 120a, 120b provided on the circumferential surface 108 in each position to further regulate fluid flow, control fluid pressure, as well as prevent fluid leakage. In particular, the plugs 128a, 128b may further provide a means for releasing fluid pressure gradually, as the plug 128a covers opening 120a as fluid flows to the tank T and the plug 128b covers opening 120b as fluid flows from the pressure port P into Port B, as shown in FIG. 6C. Conversely, the plugs 128a, 128b may allow for a steady pressure build as the plug 128a partially covers opening 120a as fluid flows into Port A, and the plug 128b covers the opening 120b as fluid flows into tank T from Port B.

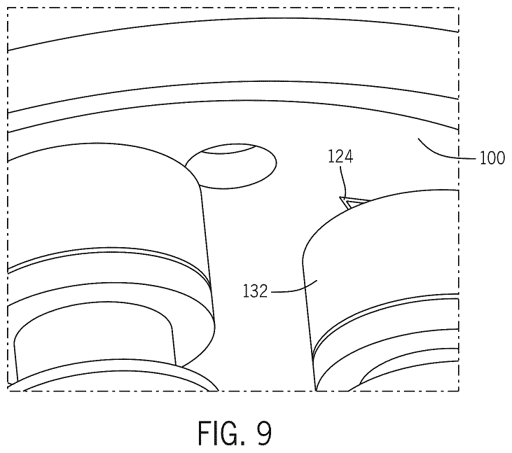

FIG. 7 illustrates a cross-sectional view of the position of the rotor 100 shown in FIG. 4A with the pressure or the third port 142c (P) in fluid communication with the first valve port 142b (A). As a result, fluid can flow from the pressure source to the first port 142b (A), as indicated by the arrow in FIG. 7. With reference to FIGS. 8 and 9, when the rotor 100 starts to rotate toward the middle (e.g., neutral) position, the fluid diversion pathways or notches 124 allow a bypassing flow to the cavity inside the valve cap 138, which is connected to a tank. For example, the notch 124 allows fluid to flow past the seal surface created by the disc 132.

The notches 124 are located on the rotation path 116, which advantageously allows the rotation angle range where the notches 124 provide flow metering to be greater. Thus, the user can move the rotor 100 a certain angle and slowly let the flow be controlled and metered. Having notches 124 that provide controlled flow allows flow metering at higher pressures and reduces or prevents a sudden loss of load or pressure drop. In general, notches allow fluid or pressure to slowly be released to the tank and can provide finer tuned flow metering compared to a rotor without notches only being slowly turned. For example, notches can provide a linear pressure decrease in the system as the rotor is turned.

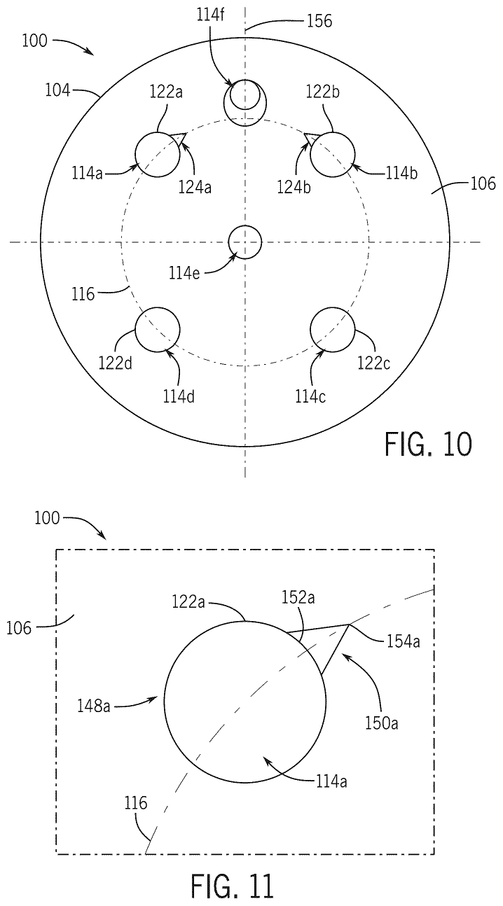

FIG. 10 illustrates a bottom schematic view of the rotor 100 and the plurality of openings 114a-f. Each of the first, second, third, and fourth openings 114a-d are disposed along the rotation path 116. The rotation path 116 defines that circumference around which the first, second, third, and fourth openings 114a-d are positioned and travel when the rotor 100 rotates and generally corresponds to a complementary positioning of the discs 132 that engage the mating surface 106 at the respective openings 114. In the illustrated embodiment, there are four openings 114a-d disposed around the rotation path 116. However, in other embodiments, additional or fewer ports may be formed in the mating surface 106 about the rotation path 116 or otherwise.

As briefly described, each of the openings 114 can define a respective perimeter 122. The perimeters 122c, 122d of the openings 114c, 114d define a generally circular geometry. In contrast, the perimeters 122a, 122d define a partially circular geometry with a cutout that defines the respective notch 124a, 124b. In this case, the notches 124 have a triangular geometry; however other geometries are possible. The notches 124a, 124b increase the open area of the respective opening 122a, 122b of the openings 114a, 114b (e.g., as compared to the perimeters 122c, 122d of the openings 114c, 114d). In general, the notches can improve the valve's lifting application performance. In particular, the notches 124a, 124b can facilitate controlled lowering of active loads by allowing for finer control of flow rates.

FIG. 11 illustrates a zoomed in version of the notch 124a. As shown, the perimeter 122a of the of the opening 114a includes a generally circular portion 148a and a generally triangular portion 150a that defines the notch 124a. The triangular portion 150a includes a base 152a that defines the same radius of curvature as the circular portion 148a of the perimeter 122a. In some cases, the notch 124 is positioned so that the base 152a is bisected by the rotation path 116. Furthermore, the triangular portion 150a includes a peak 154a. The peak 154a c disposed along the rotation path 116. In some embodiments, the triangular portion 150a may generally define a scalene triangle such that each of the three sides are different lengths. However, other geometries are possible. Furthermore, it should be appreciated that, though not shown in detail, the notch 124b can define similar (though mirrored across a vertical line 156, shown in FIG. 8) features and geometries as the notch 124a. Notably, each peak of the notches 124a, 124b extends along the respective perimeter 122a, 122b and rotation path 116 toward a centerline 156 of the rotor 100. That is, the portion of each perimeter 122a, 122b that is closest to the centerline 156 is the respective peaks (i.e., peak 154a for the opening 114a). This arrangement allow the notches to become exposed in accordance with the direction of rotation of the rotor 100, as may allow for flow metering.

In other embodiments, the perimeters (e.g., the perimeters 122a, 122b) can define other geometries that provide a controllable or metered flow as the rotor 100 moves from a high pressure fluid communication position. For example, the perimeter or port shapes can define an oval or kidney bean shape. Additionally or alternatively, a notch can also include a triangular geometry with curved sides to provide a linear or otherwise controlled flow to a tank or reservoir as the rotor rotates. In general, perimeter geometries described herein can provide an increased range of rotation of the rotor to meter flow of high pressure fluid to a tank, such as during a load lowering event.

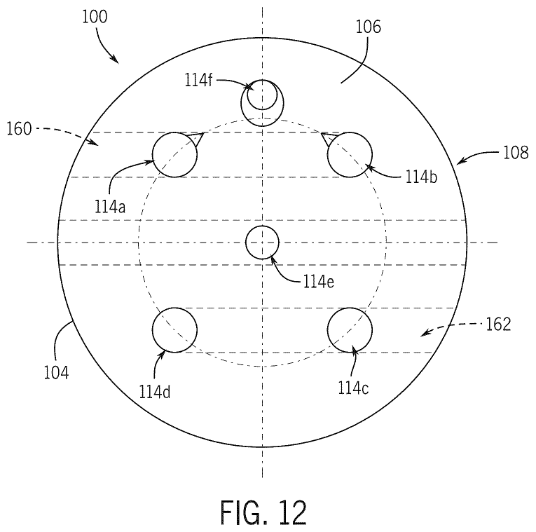

FIG. 12 illustrates another bottom schematic view of the rotor 100. As shown, the first and second openings 114a, 114b can be in fluid communication via a first internal passageway 160 extending through the rotor body 104. Similarly, the third and fourth openings 114c, 114d can be in fluid communication via a second internal passageway 162. The internal passageways 160, 162 can be configured as holes (e.g., blind holes) that were formed by drilling (or milling, etc.) through the circumferential side surface 108 of the rotor 100. Depending on the rotor configuration (e.g., number of positions and pathways) additional or fewer ports and passageways can be formed in the body 104 of the rotor 100. Furthermore, one or more of the internal passageways 160, 162 may be plugged at the circumferential side surface 108 or open to provide a port on the circumferential side surface 108 (e.g., the openings 120a, 120b of FIG. 1).

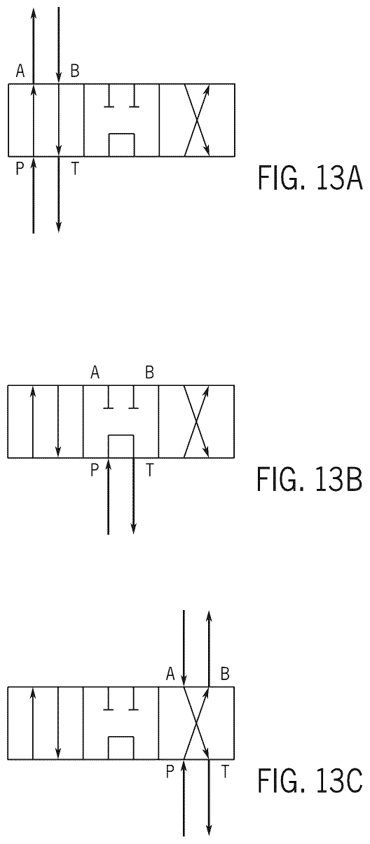

FIGS. 13A-C illustrate a rotary shear valve, such as the valve 102, in three different positions. These positions generally correspond to those illustrated in FIGS. 6A-C. For example, in FIG. 13A, the first port 142b (A) can be in fluid communication with the third port 142c (e.g., a pressure source (P)) and the second port 142a (B) can be in fluid communication with the fourth port 142d (e.g., a tank (T)). FIG. 13B illustrates the valve in a middle, or neutral position, in which neither of the first and the second ports 142a, 142b (A and B) are connected to the fourth port 142d or the third port 142c (e.g., a tank or pressure source). FIG. 13C illustrates the valve 102 in a second position in which a first port 142b (A) is in fluid communication with the fourth port 142d (e.g., a tank (T)) and the second port 142a (B) is in fluid communication with the third port 142c (e.g., the pressure source (P)).

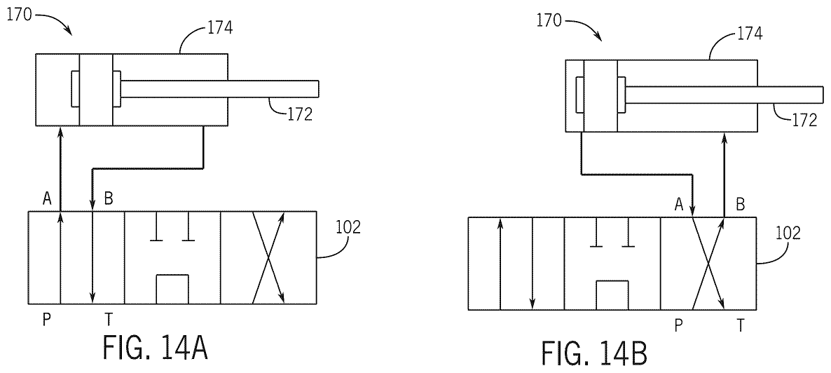

FIGS. 14A and 14B illustrate schematic representations of the rotary shear valve 102 and the fluid communication to an exemplary piston cylinder assembly 170. FIG. 14A illustrates the valve 102 in a first position that corresponds to an extension of the piston rod 172 within the cylinder 174 of the piston cylinder assembly 170. FIG. 14B illustrates the valve 102 in a second position that corresponds to a retraction of the piston rod 172 within the cylinder 174. In some embodiments, when the valve 102 is in the second position as illustrated in FIG. 14B, the first opening 114a (A) having the notch 124a may be in communication with fluid (e.g., high-pressure fluid) being expelled from the cylinder 174. The notches 124a, 124b can improve flow metering while lowering a load during lifting applications and can help the user control the flow back for a more significant range of motion during the rotor 100 rotation.

Thus, embodiments of the disclosed invention can provide a system and method for advancing and retracting a piston of a hydraulic tool via a rotary shear seal valve. The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A rotor for a directional control valve, the rotor comprising:
a rotor body defining a sealing surface, a circumferential side surface, and a stem that receives a rotational input to rotate the rotor about an axis;
a first opening formed in the sealing surface and defining a first perimeter, the first opening positioned to move along a rotation path as the rotor body rotates and the first opening having a first notch extending from the first perimeter toward a centerline of the rotor body that is perpendicular to the axis and along the rotation path; and
a second opening formed in the sealing surface and defining a second perimeter, the second opening positioned to move along the rotation path as the rotor body rotates and the second opening having a second notch extending from the second perimeter toward the centerline of the rotor body and along the rotation path.

2. The rotor of claim 1, wherein each of the first perimeter and the second perimeter has a circular shape and each of the first notch and the second notch is formed as a triangular portion.

3. The rotor of claim 2, wherein the triangular portion defines an arcuate base and a peak opposite the arcuate base, and
wherein the rotation path bisects the arcuate base and intersects the peak.

4. The rotor of claim 1, further comprising:
a third opening formed in the sealing surface and defining a third perimeter, the third perimeter defining a circular shape and having an open area that is less than an open area of the first opening; and
a fourth opening formed in the sealing surface and defining a fourth perimeter, the fourth perimeter defining a circular geometry and a surface area less than the first perimeter of the first opening.

5. The rotor of claim 4, wherein the first and the second openings are in fluid communication with each other and the third and the fourth openings are in fluid communication with each other.

6. The rotor of claim 1, wherein the first notch and the second notch are shaped to facilitate a linear decrease in pressure when the rotor is rotated.

7. The rotor of claim 1, wherein the directional control valve is rotatable between three positions:
a first position that fluidly couples the first opening with a pressure source and the second opening with a tank;
a second position that fluidly couples the first opening with the tank and the second opening with the pressure source; and
a third position where the first opening and the second opening are not fluidly coupled to the tank or the pressure source.

8. The rotor of claim 7, wherein the first position corresponds to an extension of a piston rod within a cylinder of a piston cylinder assembly, and the second position corresponds to a retraction of the piston rod within the cylinder of the piston cylinder assembly.

9. A shear seal control valve, comprising:
a valve body defining first and second ports; and
a rotor rotatably received in the valve body and having a plurality of openings formed in a mating surface of the rotor, the plurality of openings arranged to allow selective coupling of the first and second ports as the rotor rotates in the valve body,
the plurality of openings including first and second openings that each define a perimeter having a partially circular portion and a triangular portion, the respective triangular portions defining a notch of the respective first and second openings.

10. The shear seal control valve of claim 9, wherein the plurality of openings further includes a third opening and a fourth opening that define a surface area less than the perimeter of the first opening and the second opening.

11. The shear seal control valve of claim 10, wherein the first and second openings are in fluid communication with each other and the third and fourth openings are in fluid communication with each other.

12. The shear seal control valve of claim 9, wherein the notches provide a linear pressure decrease in hydraulic pressure as the rotor is rotated from a first position to a second position.

13. The shear seal control valve of claim 12, wherein the first opening is coupled with a pressure source and the second opening is coupled with a tank in the first position.

14. The shear seal control valve of claim 13, wherein the first opening is coupled with the tank and the second opening is coupled with the pressure source in the second position.

15. A method of operating a piston via a rotary shear seal valve, the method comprising:
rotating a rotor to a first position;
fluidly coupling a pressure source with a first opening and fluidly coupling a second opening with a tank;
extending a piston within a cylinder of a piston cylinder assembly that causes an operation on a workpiece;
rotating a rotor to a second position;
fluidly coupling a first notch of the first opening with the tank and fluidly coupling a second notch of the second opening with the pressure source; and
retracting the piston within the cylinder of the piston cylinder assembly.

16. The method of claim 15, wherein the rotor rotates in a first rotational direction to reach the first position and in a second rotational direction to reach the second position, the first rotational direction being opposite the first rotational direction.

17. The method of claim 15, further comprising:
rotating a rotor to a third position; and
fluidly decoupling the first opening, the second opening, the pressure source, and the tank.

18. The method of claim 17, wherein the third position is a neutral position between the first position and the second position that blocks fluid flow through the first opening and the second opening.

19. The method of claim 15, wherein the first notch and the second notch are located on a rotation path of the rotor that increases flow metering.

20. The method of claim 19, wherein the first notch and the second notch are triangular-shaped.
